(19) United States
(12) Patent Application Publication
(10) Pub. No.: US 2024/0327949 A1
(43) Pub. Date: Oct. 3, 2024

(54) ALUMINUM PRODUCTION POWERED BY GEOTHERMAL ENERGY

(71) Applicant: EnhancedGEO Holdings, LLC, St. Petersburg, FL (US)

(72) Inventors: Greg Lindberg, Thonotosassa, FL (US); Kimberly C. Conner, Wetumpka, AL (US)

(21) Appl. No.: 18/130,234

(22) Filed: Apr. 3, 2023

(51) Int. Cl. C22B 21/02; B22D 21/00; C22B 1/24; C22B 3/06; C22B 3/22; C22B 5/02; C22B 34/12; C22B 59/00; C25C 3/06; F03G 4/00; F24T 10/10; F24V 50/00

(52) U.S. Cl. CPC C22B 21/02; B22D 21/007; C22B 1/24; C22B 3/06; C22B 3/22; C22B 5/02; C22B 34/124; C22B 59/00; C25C 3/06; F03G 4/00; F24T 10/10; F24V 50/00

(57) ABSTRACT

A geothermally powered aluminum production subsystem includes a geothermal system with a wellbore extending from a surface into an underground magma reservoir. A hopper receives a bauxite ore that is crushed and provided to a digestor. The digestor is heated by a heat transfer fluid heated by the geothermal system, and a product of the digestor is used to prepare aluminum.

### TECHNICAL FIELD

The present disclosure relates generally to geothermal power systems and related methods and more particularly to aluminum production powered by geothermal energy.

### BACKGROUND

Aluminum is produced by refinement through energy intensive processes involving heat and mechanical means. Considerable energy is expended to supply heat and power the equipment used to perform such production. Renewable energy sources, such as solar power and wind power, can be unreliable and have relatively low power densities, such that they may be insufficient to reliably power aluminum production equipment. As such, production equipment typically relies on non-renewable fuels for power. There exists a need for improved aluminum production processes.

### SUMMARY

This disclosure recognizes the previously unidentified and unmet need for a reliable renewable energy source for aluminum production. This disclosure provides a solution to this unmet need in the form of an aluminum production subsystem that is powered at least partially by geothermal energy. A geothermal system harnesses heat from a geothermal resource with a sufficiently high temperature that can be used to power equipment used in aluminum production. For example, steam may be obtained from a geothermal system and used to heat one or more reactor vessels to obtain aluminum from an initial ore provided to the aluminum production subsystem. For example, heated fluid from a geothermal system may be used to heat a heat exchanger to maintain appropriate temperatures for reactions in a digestor. As another example, heated fluid may be used to heat a calcinator to cause desired dehydration reactions. In some cases, one or more geothermally powered motors may be powered with steam from a geothermal system and used to support mechanical operations of the aluminum production process, such as to crush and grind bauxite. As another example, the same or a different geothermally powered motor may power a pump or conveyor that is used to move materials between different process equipment for aluminum production. One or more turbines may be powered by the steam to provide electricity for any electronic components of the aluminum production subsystems (e.g., electronic controllers, sensors, etc.).

Most conventional geothermal systems are used for heating applications, such as to heat a home or other space. Geothermally sourced steam has not been used to power aluminum production subsystems. Most previous geothermal systems tap into low temperature resources of less than 194° F. that are relatively near the surface, significantly limiting applications and locations where previous geothermal systems can be deployed. In addition to other disadvantages of previous geothermal technology, the inability of previous technology to efficiently and reliably access high-temperature underground geothermal resources renders conventional geothermal systems technologically and financially impractical.

In some embodiments, the geothermal system that powers the aluminum production subsystems is a closed geothermal system that exchanges heat with an underground geothermal reservoir. The geothermal reservoir may be magma. For example, an underground geothermal reservoir, such as a magma reservoir, may facilitate the generation of high-temperature, high-pressure steam, while avoiding problems and limitations associated with previous geothermal technology. The geothermal systems of this disclosure generally include a wellbore that extends from a surface into an underground thermal reservoir, such as a magma. A closed heat-transfer loop is employed in which a heat transfer fluid is pumped into the wellbore, heated via contact with the underground thermal reservoir, and returned to the surface to power an aluminum production subsystem located within a sufficient proximity to the wellbore.

The geothermal system of this disclosure may harness a geothermal resource with sufficiently high amounts of energy from magmatic activity such that the geothermal resource does not degrade significantly over time. This disclosure illustrates improved systems and methods for capturing energy from magma reservoirs, dykes, sills, and other magmatic formations that are significantly higher in temperature than heat sources that are accessed using previous geothermal technologies and that can contain an order of magnitude higher energy density than the geothermal fluids that power previous geothermal technologies. In some cases, the present disclosure can significantly decrease aluminum production costs and/or reliance on non-renewable resources for aluminum production subsystem operations. In some cases, the present disclosure may facilitate more efficient aluminum production in regions where access to reliable power is currently unavailable or transport of non-renewable fuels is challenging. The systems and methods of the present disclosure may also or alternatively aid in decreasing carbon emissions.

Certain embodiments may include none, some, or all of the above technical advantages. One or more technical advantages may be readily apparent to one skilled in the art from figures, description, and claims included herein.

### BRIEF DESCRIPTION OF THE FIGURES

For a more complete understanding of the present disclosure, reference is now made to the following description, taken in conjunction with the accompanying drawings and detailed description, in which like reference numerals represent like parts.

FIG. 1 is a diagram of underground regions in the Earth.

FIG. 2 is a diagram of a conventional geothermal system.

FIG. 3 is a diagram of an example improved geothermal system of this disclosure.

FIG. 4 is a diagram of an example system in which aluminum production is powered by the improved geothermal system of FIG. 3.

FIG. 5 is a diagram of the example aluminum production subsystem of FIG. 4 in greater detail.

FIG. 6 is a flowchart of an example method for operating the system of FIG. 4.

FIG. 7 is a flowchart of another example method for operating the system of FIG. 4.

FIG. 8 is a diagram of an example red mud recovery subsystem that extracts resources from a waste byproduct obtained from the system of FIG. 5.

FIG. 9 is a flowchart of an example method for operating the system of FIG. 8.

FIG. 10 is a diagram of an example system for performing thermal processes of FIGS. 3 and 4.

### DETAILED DESCRIPTION

Embodiments of the present disclosure and its advantages will become apparent from the following detailed description when considered in conjunction with the accompanying figures. In the figures, each identical, or substantially similar component that is illustrated in various figures is represented by a single numeral or notation. For purposes of clarity, not every component is labeled in every figure, nor is every component of each embodiment shown where illustration is not necessary to allow those of ordinary skill in the art to understand the disclosure.

The present disclosure includes unexpected observations, which include the following: (1) magma reservoirs can be located at relatively shallow depths of less than 2.5 km; (2) the top layer of a magma reservoir may have relatively few crystals with little or no mush zone; (3) rock near or around magma reservoirs is generally not ductile and can support fractures; (4) a magma reservoir does not decline in thermal output over at least a two-year period; (5) eruptions at drill sites into magma reservoirs are unlikely (e.g., eruptions have not happened at African and Icelandic drill sites in over 10,000 years and it is believed a Kilauea, Hawaii drill site has never erupted); and (6) drilling into magma reservoirs can be reasonably safe.

As used herein, “magma” refers to extremely hot liquid and semi-liquid rock under the Earth's surface. Magma is formed from molten or semi-molten rock mixture found typically between 1 km to 10 km under the surface of the Earth. As used herein, “borehole” refers to a hole that is drilled to aid in the exploration and recovery of natural resources, including oil, gas, water, or heat from below the surface of the Earth. As used herein, a “wellbore” refers to a borehole either alone or in combination with one or more other components disposed within or in connection with the borehole in order to perform exploration and/or recovery processes. As used herein, “fluid conduit” refers to any structure, such as a pipe, tube, or the like, used to transport fluids. As used herein, “heat transfer fluid” refers to a fluid, e.g., a gas or liquid, that takes part in heat transfer by serving as an intermediary in cooling on one side of a process, transporting and storing thermal energy, and heating on another side of a process. Heat transfer fluids are used in processes requiring heating or cooling.

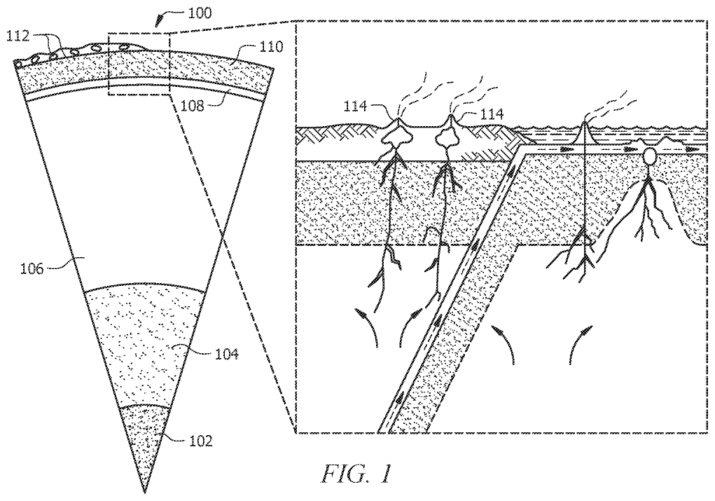

FIG. 1 is a partial cross-sectional diagram of the Earth depicting underground formations that can be tapped by geothermal systems of this disclosure (e.g., for generating geothermal power). The Earth is composed of an inner core 102, outer core 104, lower mantle 106, transition zone 108, upper mantle 110, and crust 112. There are places on the Earth where magma reaches the surface of the crust 112 forming volcanos 114. However, in most cases, magma approaches only within a few miles or less from the surface. This magma can heat ground water to temperatures sufficient for certain geothermal power production. However, for other applications, such as geothermal energy production, more direct heat transfer with the magma is desirable.

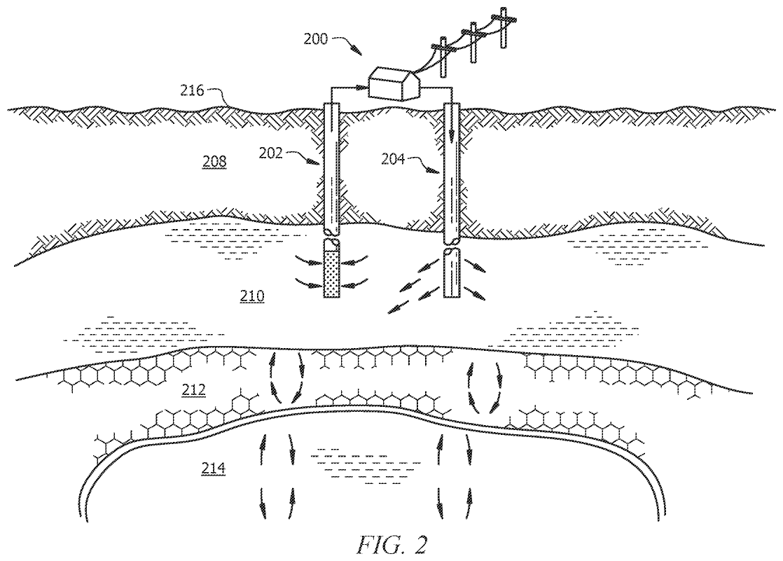

FIG. 2 illustrates a conventional geothermal system 200 that harnesses energy from heated ground water for power generation. The conventional geothermal system 200 is a “flash-plant” that generates power from a high-temperature, high-pressure geothermal water extracted from a production well 202. The production well 202 is drilled through rock layer 208 and into the geothermal fluid layer 210 that serves as the source of geothermal water. The geothermal water is heated indirectly via heat transfer with intermediate layer 212, which is in turn heated by magma reservoir 214. Convective heat transfer (illustrated by the arrows indicating that hotter fluids rise to the upper portions of their respective layers before cooling and sinking, then rising again) may facilitate heat transfer between these layers. Geothermal water from the geothermal fluid layer 210 flows to the surface 216 and is used for geothermal power generation. The geothermal water (and possibly additional water or other fluids) is then injected back into the geothermal fluid layer 210 via an injection well 204.

The configuration of conventional geothermal system 200 of FIG. 2 suffers from drawbacks and disadvantages, as recognized by this disclosure. For example, because geothermal water is a polyphase fluid (i.e., not pure water), the geothermal water flashes at various points along its path up to the surface 216, creating water hammer, which results in a large amount of noise and potential damage to system components. The geothermal water is also prone to cause scaling and corrosion of system components. Chemicals may be added to partially mitigate these issues, but this may result in considerable increases in operational costs and increased environmental impacts, since these chemicals are generally introduced into the environment via injection well 204.

### Example Improved Geothermal System

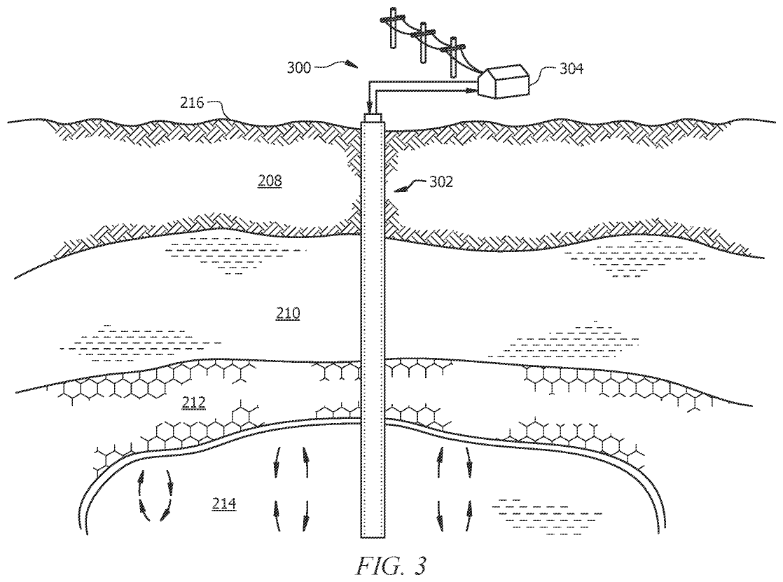

FIG. 3 illustrates an example magma-based geothermal system 300 of this disclosure. The magma-based geothermal system 300 includes a wellbore 302 that extends from the surface 216 at least partially into the magma reservoir 214. The magma-based geothermal system 300 is a closed system in which a heat transfer fluid is provided down the wellbore 302 to be heated and returned to a thermal process system 304 (e.g., for power generation and/or any other thermal processes of interest). As such, geothermal water is not extracted from the Earth, resulting in significantly reduced risks associated with the conventional geothermal system 200 of FIG. 2, as described further below. Heated heat transfer fluid is provided to the thermal process system 304. The thermal process system 304 is generally any system that uses the heat transfer fluid to drive a process of interest. For example, the thermal process system 304 may include an electricity generation system support thermal processes requiring higher temperatures/pressures than could be reliably or efficiently obtained using previous geothermal technology, such as the conventional geothermal system 200 of FIG. 2. Further details of components of an example thermal process system 304 are provided with respect to FIG. 10 below.

The magma-based geothermal system 300 provides technical advantages over previous geothermal systems, such as the conventional geothermal system 200 of FIG. 2. The magma-based geothermal system 300 can achieve higher temperatures and pressures for increased energy generation (and/or for more effectively driving other thermal processes). For example, because of the high energy density of magma in magma reservoir 214 (e.g., compared to that of geothermal water of the geothermal fluid layer 210), wellbore 302 can generally create the power of many wells of the conventional geothermal system 200 of FIG. 2. Furthermore, the magma-based geothermal system 300 has little or no risk of thermal shock-induced earthquakes, which might be attributed to the injection of cooler water into a hot geothermal zone, as is performed using the conventional geothermal system 200 of FIG. 2. The heat transfer fluid is generally not substantially released into the geothermal zone, resulting in a decreased environmental impact and decreased use of costly materials (e.g., chemical additives that are used and introduced to the environment in great quantities during some conventional geothermal operations). The magma-based geothermal system 300 may also have a simplified design and operation compared to those of previous systems. For instance, fewer components and reduced complexity may be needed at the thermal process system 304 because only clean heat transfer fluid (e.g., steam) reaches the surface 216. There may be no need or a reduced need to separate out solids or other impurities that are common to geothermal water. The example magma-based geothermal system 300 may include further components not illustrated in FIG. 3.

Further details and examples of different configurations of geothermal systems and methods of their preparation and operation are described in U.S. patent application Ser. No. 18/099,499, filed Jan. 20, 2023, and titled “Geothermal Power from Superhot Geothermal Fluid and Magma Reservoirs”; U.S. patent application Ser. No. 18/099,509, filed Jan. 20, 2023, and titled “Geothermal Power from Superhot Geothermal Fluid and Magma Reservoirs”; U.S. patent application Ser. No. 18/099,514, filed Jan. 20, 2023, and titled “Geothermal Power from Superhot Geothermal Fluid and Magma Reservoirs”; U.S. patent application Ser. No. 18/099,518, filed Jan. 20, 2023, and titled “Geothermal Power from Superhot Geothermal Fluid and Magma Reservoirs”; U.S. patent application Ser. No. 18/105,674, filed Feb. 3, 2023, and titled “Wellbore for Extracting Heat from Magma Chambers”; U.S. patent application Ser. No. 18/116,693, filed Mar. 2, 2023, and titled “Geothermal systems and methods with an underground magma chamber”; U.S. patent application Ser. No. 18/116,697, filed Mar. 2, 2023, and titled “Method and system for preparing a geothermal system with a magma chamber”; and U.S. Provisional Patent Application No. 63/444,703, filed Feb. 10, 2023, and titled “Geothermal systems and methods using energy from underground magma reservoirs”, the entirety of each of which is hereby incorporated by reference.

### Geothermally Powered Aluminum Production

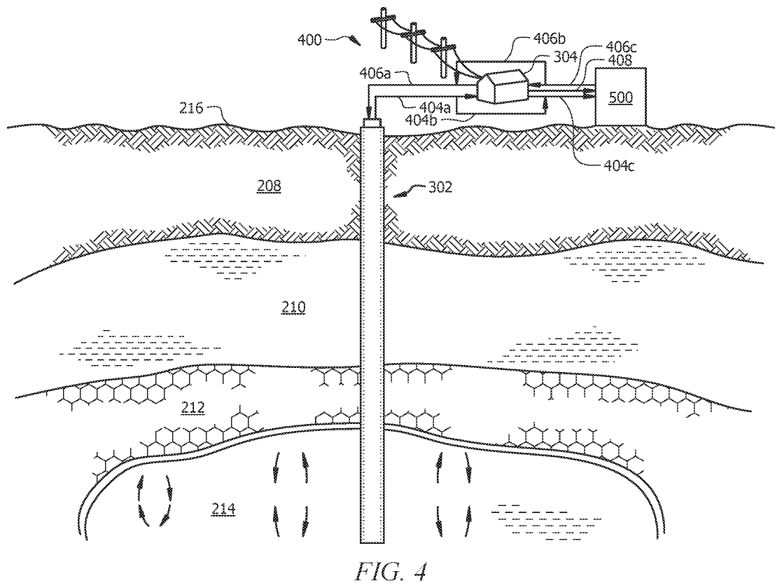

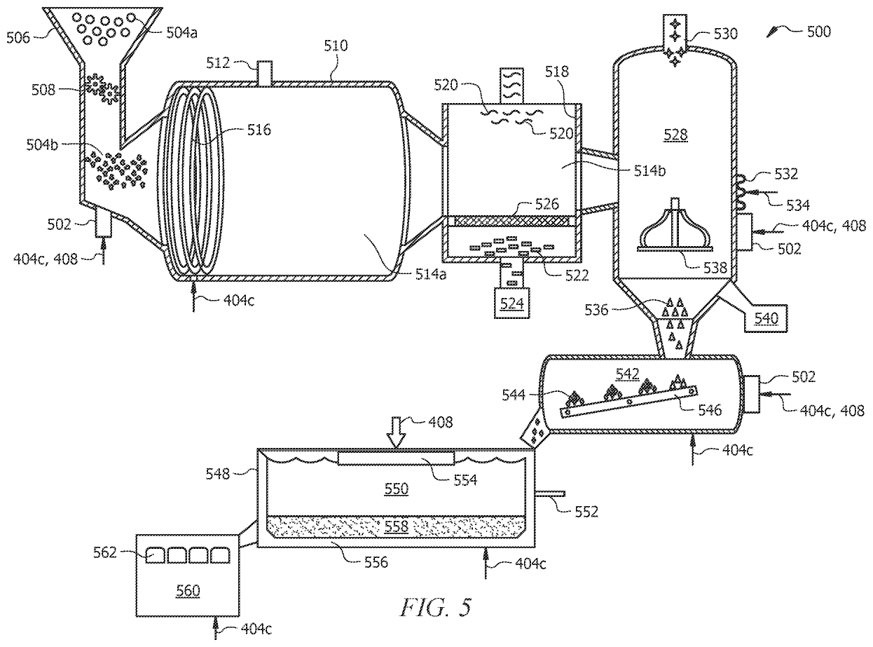

FIG. 4 illustrates an example combined geothermal and aluminum production system 400 of this disclosure. The combined geothermal and aluminum production system 400 includes all or a portion of the components of the magma-based geothermal system 300 described above with respect to FIG. 3 as well as geothermally powered aluminum production subsystem 500 for producing aluminum 562. An example of the geothermally powered aluminum production subsystem 500 is described in greater detail below with respect to FIG. 5. The combined geothermal and aluminum production system 400 may include all or a portion of the thermal process system 304. In operation, heat transfer fluid is injected into the wellbore 302, which extends from the surface 216 into the magma reservoir 214 underground. The heated heat transfer fluid can be conveyed to the thermal process system 304 as heat transfer fluid 404a that can be used to drive processes, such as the generation of electricity by turbines 1004 and 1008 in FIG. 10. Heat transfer fluid 404a may be referred to in the alternative as a stream of heat transfer fluid 404a. Heat transfer fluid 404c, which can be formed from any remaining amount of heat transfer fluid 404a (e.g., steam) exiting from the thermal process system 304 and/or the wellbore bypass stream, i.e., heat transfer fluid 404b, is provided to the geothermally powered aluminum production subsystem 500. The electricity 408 may be used in addition to or in place of heat transfer fluid 404c for powering electrical and mechanical processes in the geothermally powered aluminum production subsystem 500.

As described in greater detail below with respect to FIG. 5, the geothermally powered aluminum production subsystem 500 uses the heat transfer fluid 404c to produce aluminum 562. For example, a motor of the geothermally powered aluminum production subsystem 500 may be powered by the heat of heat transfer fluid 404c, and the motor may provide motion to a hopper 506, crusher 508, conveyor 546, fluid pump(s), and/or the like of the geothermally powered aluminum production subsystem 500 (see FIGS. 5-8 and corresponding descriptions below). As another example, the geothermally powered aluminum production subsystem 500 may include a fluid pump with a motor that is powered at least in part by the heat transfer fluid (e.g., steam) heated in the wellbore 302. As another example, the geothermally powered aluminum production subsystem 500 may include a motor that aids in moving a mixer in a precipitation tank and is powered by heat transfer fluid (e.g., steam) heated in the wellbore 302. More detailed examples of operations of geothermally powered aluminum production subsystem 500 are provided below with respect to FIGS. 5-8.

Heat transfer fluid (e.g., condensed steam) that is cooled and/or or decreased in pressure after powering the geothermally powered aluminum production subsystem 500 may be returned to the wellbore 302 as heat transfer fluid 406a. For instance, as shown in the example of FIG. 4, a stream of return heat transfer fluid 406c may be provided back to the thermal process system 304, used to drive one or more reactions or processes, and then expelled as heat transfer fluid 406a for return to the wellbore 302. The heat transfer fluid 406a can also include a bypass stream of heat transfer fluid 406b, which can be formed from heat transfer fluid 406c, in whole or in part. Restated, thermally processed return stream of heat transfer fluid 406a includes heat transfer fluid (e.g., condensed steam) from the thermal process system 304 and/or the bypass stream of heat transfer fluid 406b. Thermally processed return stream of heat transfer fluid 406a that is sent back to the wellbore 302 may be water (or another heat transfer fluid), while the stream of heat transfer fluid 404a received from the wellbore 302 is steam (or another heat transfer fluid at an elevated temperature and/or pressure). While the example of FIG. 4 includes the thermal process system 304 of FIG. 3, in some cases, the combined geothermal and aluminum production system 400 may exclude all or a portion of the thermal process system 304. For example, the wellbore stream of heat transfer fluid 404a from the wellbore 302 may be provided directly to the geothermally powered aluminum production subsystem 500 (see wellbore bypass stream of heat transfer fluid 404b described above).

Heat transfer fluid in streams 404a-c and 406a-c may be any appropriate fluid for absorbing heat within the wellbore 302 and driving operations of the geothermally powered aluminum production subsystem 500 and, optionally the thermal process system 304. For example, the heat transfer fluid may include water, a brine solution, one or more refrigerants, a thermal oil (e.g., a natural or synthetic oil), a silicon-based fluid, a molten salt, a molten metal, or a nanofluid (e.g., a carrier fluid containing nanoparticles). A molten salt is a salt that is a liquid at the high operating temperatures experienced in the wellbore 302 (e.g., at temperatures between 1,600 and 2,300° F.). In some cases, an ionic liquid may be used as the heat transfer fluid. An ionic liquid is a salt that remains a liquid at more modest temperatures (e.g., at or near room temperature). In some cases, a nanofluid may be used as the heat transfer fluid. The nanofluid may be a molten salt or ionic liquid with nanoparticles, such as graphene nanoparticles, dispersed in the fluid. Nanoparticles have at least one dimension of 100 nanometers (nm) or less. The nanoparticles increase the thermal conductivity of the molten salt or ionic liquid carrier fluid. This disclosure recognizes that molten salts, ionic liquids, and nanofluids can provide improved performance as heat transfer fluids in the wellbore 302. For example, molten salts and/or ionic liquids may be stable at the high temperatures that can be reached in the wellbore 302. The high temperatures that can be achieved by these materials not only facilitate increased energy extraction but also can drive thermal processes that were previously inaccessible using previous geothermal technology. The heat transfer fluid may be selected at least in part to limit the extent of corrosion of surfaces of the combined geothermal and aluminum production system 400. As an example, the heat transfer fluid may be water. The water is supplied to the wellbore 302 as stream of heat transfer fluid 406a in the liquid phase and is transformed into steam within the wellbore 302. The steam is received as stream of heat transfer fluid 404a and used use to drive the geothermally powered aluminum production subsystem 500.

### Example Geothermally Powered Aluminum Production System

FIG. 5 shows an example of the geothermally powered aluminum production subsystem 500 of FIG. 4 in greater detail. The configuration of FIG. 5 is provided as an example only. The geothermally powered aluminum production subsystem 500 may include more or fewer components, and the components may be arranged in different configurations in order to produce aluminum 562. The example geothermally powered aluminum production subsystem 500 includes the hopper 506, the crusher 508, a digestor 510, a clarification tank 518, a precipitation tank 528, a calcinator 542, a smelter 548, and a crucible 560. These main components and other components may be powered at least partially by geothermal energy from the heat transfer fluid 404c (e.g. steam), which obtained its heat from the magma reservoir 214 via the stream of heat transfer fluid 404a. This heat transfer fluid 404c may be used directly to heat components in geothermally powered aluminum production subsystem 500 or to heat a secondary heat transfer fluid. The secondary heat transfer fluid may be any similarly suitable fluid as chosen in the primary heat transfer fluid 404c. The heat transfer fluid 404c or secondary heat transfer fluid may be used to heat components or may be converted to mechanical or electrical energy to perform operations in the geothermally powered aluminum production subsystem 500.

During operation of the geothermally powered aluminum production subsystem 500, a bauxite 504a (an aluminum-bearing mineral) enters the hopper 506 and is crushed and ground by the crusher 508. The hopper 506 can be any appropriate type of open funnel that receives bauxite. It may contain a screen or a feeder. A geothermally powered motor 502 coupled to the crusher 508 powers the crusher 508. The geothermally powered motor 502 can be coupled to system components, such as the crusher 508, using conventional means, e.g., mechanical, electrical, pneumatic, etc., which are omitted for the sake of simplicity. The crusher 508 can be any appropriate type of machine that operates by rolling, impacting, milling, vibrating, and/or grinding. For example, the crusher may be a jaw crusher, impact crusher, or ball mill. The geothermally powered motor 502 may be geothermally powered directly by the heat transfer fluid 404c that is heated by the magma reservoir 214. An example of geothermally powered motor is described in U.S. Provisional Patent Application No. 63/448,929, filed Feb. 28, 2023, and titled “Drilling Equipment Powered by Geothermal Energy,” the entirety of which is incorporated herein by reference.

A crushed and ground bauxite 504b enters the digestor 510 to be processed into a slurry 514a. The digestor 510 is any vessel that can accommodate inputs for reactants and can be capable of maintaining a desired temperature to facilitate the extraction of alumina from the crushed and ground bauxite 504b. The digestor 510 combines the crushed and ground bauxite 504b with reactants, represented generally as block 512 (e.g., sodium hydroxide and lime) and water. The reactants 512 and water can be introduced into the digestor 510 via conventional means and are omitted for the sake of simplicity. The crushed and ground bauxite 504b may contain minerals such as gibbsite (Al(OH)₃), bohmite (γ-AlO(OH)), and diaspore (α-AlO(OH)). The digestor 510 is maintained at an elevated temperature appropriate for the mineral content of the bauxite 504b (e.g., 140° C. for high gibbsite content and 280° C. for high bohmite content) and a steam saturation pressure for the temperature of the digestion process. The elevated temperature of the digestor 510 can be provided by a heat exchanger 516, which can be heated by heat transfer fluid 404c. The heat exchanger 516 is depicted as disposed within the digestor 510 in FIG. 5 to provide heat directly to the slurry 514a, but in other embodiments the heat exchanger 516 can be arranged to heat the walls of the digester 510 which can then heat the slurry 514a indirectly. Heat exchange between the heat exchanger 516 and the slurry 514a and/or digestor 510 induces a reaction to form a slurry 514a (i.e., pregnant liquor) containing sodium aluminate supersaturated solution. As an example, gibbsite may undergo the reaction Al(OH)₃+Na⁺+OH⁻→Al(OH)₄⁻+Na⁺. Bohmite and diaspore may undergo the reaction AlO(OH)+Na⁺+OH⁻+H₂O→Al(OH)₄⁺+Na⁺. Examples of the heat exchanger 516 include shell-and-tube or tube-in-tube type heat exchangers. During digestion in the digestor 510, silica and other soluble impurities may be removed from the slurry 514a.

The slurry 514a may be further processed in the clarification tank 518 (e.g., via the Bayer process). The clarification tank 518 is any vessel that can filter and remove insoluble impurities. The slurry 514a is combined with flocculants 520 and is then clarified by a filter 526. The filter 526 is any machine capable of removing at least one component from the slurry 514a. Filtration may be performed by chemical and/or mechanical means. In the example of FIG. 5, the filter 526 is driven by a geothermally powered motor 502. The filter 526 can be a drum filter or vacuum filter, as examples. Red mud 522 may form as an insoluble bauxite residue that combines with the flocculants 520 and settles by gravity and is removed from the slurry 514a to produce clarified slurry 514b. In the example of FIG. 5, the red mud 522 is provided to a waste collection reservoir 524 and may be further processed to recover byproducts of economic value (see below).

The clarified slurry 514b is combined with aluminum hydroxide seed crystals 530 in the precipitation tank 528. The precipitation tank 528 is any vessel capable of accommodating an input to receive seed crystals and holding, cooling, and mixing a slurry to facilitate a precipitation reaction. The clarified slurry 514b is mixed by the mixer 538, which may be driven by a geothermally powered motor 502 and/or cooled by an absorption chiller 532. The absorption chiller 532 generates a cooling fluid 534 by condensing the heat transfer fluid 406c. The mixer 538 is any machine capable of agitating the clarified slurry 514b contained by the precipitation tank 528. In the example of FIG. 5, a geothermally powered motor 502 rotates the mixer 538. The precipitation reaction is the reverse of the gibbsite dissolution reaction in the digestion stage: Al(OH)₄⁻+Na⁺→Al(OH)₃+Na⁺+OH⁻. Aluminum hydroxide 536 precipitates in the precipitation tank 528. The remaining spent liquor 540 may be removed from the precipitation tank 528 to be processed and recycled for use in slurry production.

The aluminum hydroxide 536 is then heated in the calcinator 542 to remove bonded water molecules to produce aluminum oxide 544. The calcinator 542 is any vessel that can be heated and can receive and handle the aluminum hydroxide 536. The calcinator 542 is heated by a heat transfer fluid 404c. A conveyor 546 conveys the aluminum hydroxide 536 through the calcinator 542 during the calcination process across the length of the chamber and is driven by a geothermally powered motor 502. The conveyor 546 can convey the aluminum hydroxide 536 by a rolling motion, sliding motion, or radial motion, for example, along a belt or roller system, or moved in a fluidized bed. The calcinator 542 can be a rotary kiln, gas suspension calciner, fluidized bed calciner, or fluid flash calciner. An example dehydration reaction facilitated by calcination is 2Al(OH)₃→Al₂O₃+3H₂O. Aluminum oxide 544 is a product of this process.

The aluminum oxide 544 may be electrolytically reduced via the Hall-Heroult process or another appropriate process in a smelter 548. Electrolytic reduction is driven by a current between an anode 554 and a cathode 556 which lines the smelting bath 550. Example materials that may be used for the cathode 556 and anode 554 are carbon blocks and liners, for example, graphite, anthracite, and/or petroleum coke blocks and/or liners. An electrolyte, represented generally as block 552, is fed into the smelting bath 550 using conventional means that are omitted for the sake of simplicity. The electrolyte 552 may also facilitate the dissolution of the aluminum oxide 544. The electrolyte 552 may be molten cryolite (sodium aluminum fluoride), which may provide the added benefits of lowering the melting point of the solution and having a lower density than molten aluminum 558. These features facilitate the formation of a layer above the molten aluminum 558 that can then easily be removed from the bottom of the smelting bath 550. During electrolysis, molten aluminum 558 deposits at the cathode, while the oxygen from the aluminum oxide 544 simultaneously combines with the carbon to create carbon dioxide. Smelting requires a high energy demand. This disclosure provides a solution to this problem by facilitating the operation of the smelter 548 using geothermal energy. For example, the current used for electrolysis may be supplied by electricity 408 derived from the conversion of heat in the heat transfer fluid 404c by turbines (e.g., turbines 1004, 1008 of FIG. 10), and the smelting bath is heated by a heat transfer fluid 404c.

A molten aluminum 558 is tapped from the smelter 548 and then cast in a crucible 560. The crucible 560 can be any vessel capable of receiving and containing the molten aluminum 558, cooling the molten aluminum 558, and forming it into masses of various shapes and sizes. The crucible 560 may be heated by the heat transfer fluid 404c in a similar manner that the digestor 510 is heated by the heat transfer fluid 404c. The final product of aluminum 562 may be cast into any desired shape, for example, ingots, slabs, billets, and t-bars.

### Example Geothermally Powered Aluminum Production Processes

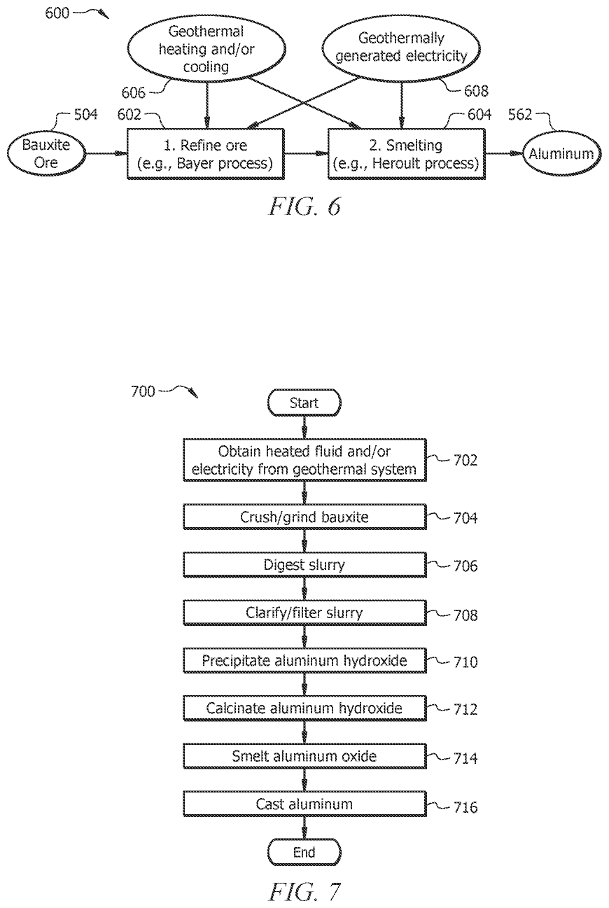

FIG. 6 shows an example method 600 of operating the geothermally powered aluminum production subsystem 500 of FIG. 5. The method 600 includes a refining subprocess 602 to refine ore and a smelting subprocess 604 to smelt aluminum. Geothermal heating and/or cooling 606 and geothermally generated electricity 608 can be used to complete the refining subprocess 602 and the smelting subprocess 604. The refining subprocess 602 begins with bauxite ore 504. The bauxite ore 504 undergoes the refining subprocess 602 that can utilize geothermal heating to extract alumina from a hot caustic slurry that dissolves the bauxite ore 504, followed by utilizing cooled geothermal fluids to precipitate aluminum hydroxide from the slurry and utilizing geothermal heating to dehydrate the aluminum hydroxide to produce aluminum oxide. The aluminum oxide undergoes the smelting subprocess 604 that can utilize geothermal heating to supply heat and to produce geothermally generated electricity 608 to power electrolytic reduction to produce molten aluminum which can then be transferred to a geothermally heated crucible to cast the aluminum 562 as the final product.

Modifications, omissions, or additions may be made to method 600 depicted in FIG. 6. Method 600 may include more, fewer, or other steps. For example, at least certain steps may be performed in parallel or in any suitable order. While at times discussed as aluminum production subsystem 500 performing steps, any suitable component of the aluminum production subsystem 500 or other components of a geothermal system may perform or may be used to perform one or more steps of the method 600.

FIG. 7 shows another example method 700 of operating the geothermally powered aluminum production subsystem 500 in FIG. 7. The method 700 may begin at step 702 where the heated heat transfer fluid 404c and/or electricity 408 is received from the geothermal system, as described above with respect to FIGS. 1-4. At step 704, bauxite is crushed and/or ground using a geothermally powered motor 502. At step 706, a slurry is produced by combining the crushed and/or ground bauxite with reactants and water heated by the heat transfer fluid 404c to extract alumina in the slurry. At step 708, the slurry is clarified and/or filtered. At step 710, the clarified slurry is cooled and mixed to precipitate solid aluminum hydroxide 536. Step 710 may be performed using the absorption chiller 532 and/or mixer 538 described with respect to FIG. 5 above. At step 712, the calcinator heats the aluminum hydroxide 536 with the heat transfer fluid 404c, thereby producing aluminum oxide 544. At step 714, a smelter 548 reduces the aluminum oxide 544 in the presence of cryolite and heats the mixture with the heat transfer fluid 404c to produce molten aluminum. Step 714 may be driven by current between the anode and cathode described in FIG. 5, the current being generated by electricity 408 from the geothermally powered turbines configured to use the heat transfer fluid 404a heated by the geothermal system. At step 716, the molten aluminum 558 is cast in a crucible 560.

Modifications, omissions, or additions may be made to method 700 depicted in FIG. 7. Method 700 may include more, fewer, or other steps. For example, at least certain steps may be performed in parallel or in any suitable order. While at times discussed as aluminum production subsystem 500 performing steps, any suitable component of the aluminum production subsystem 500 or other components of a geothermal system may perform or may be used to perform one or more steps of the method 700.

### Geothermally Powered Processing of Aluminum Production Byproducts

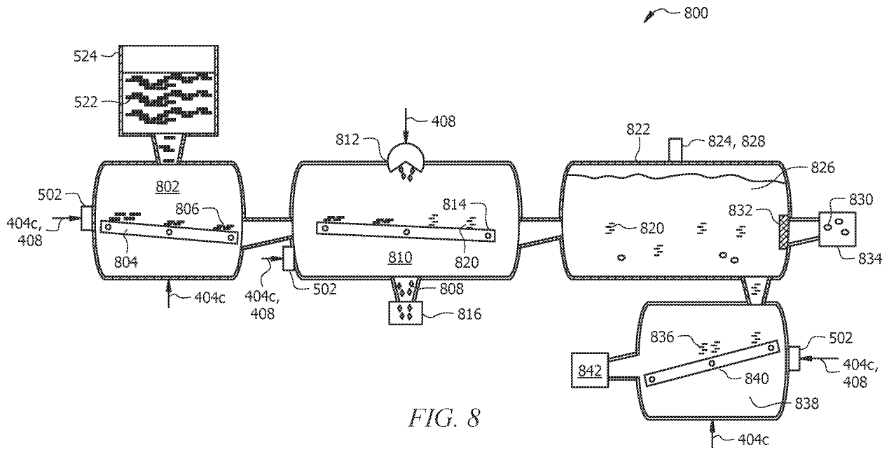

FIG. 8 shows an example of a geothermally powered red mud processing subsystem 800. As described with respect to FIG. 5 above, red mud 522 is stored in a waste collection reservoir 524 where it can be processed to recover other useful materials. In the example, of FIG. 8, the red mud 522 is processed to recover iron as magnetite 808, titanium/scandium 830 (and other metals and/or rare earth elements), and to produce construction materials 842. The configuration of FIG. 8 is provided as an example only. The geothermally powered red mud processing subsystem 800 equipment may include more or fewer components, and the components may be arranged in different configurations in order to produce the magnetite 808, titanium/scandium 830, and construction materials 842.

The example geothermally powered red mud processing subsystem 800 includes a roasting furnace 802, a magnetic separator 810, an acid leaching tank 822, and a construction material pipeline 838. These main components and optionally other components are powered at least partially by geothermal energy from a stream of heat transfer fluid 404c with heat from a wellbore 302 and/or using geothermally generated electricity 408. As described above, the heat of transfer fluid 404c (e.g. steam) is obtained in the wellbore 302 via heat transfer with the magma reservoir 214. This heat transfer fluid 404c, which may include heat transfer fluid exiting the thermal process system 304 and/or heat transfer fluid 404b bypassing thermal process system 304, can be used directly to heat components in the geothermally powered red mud processing subsystem 800 or to heat a secondary heat transfer fluid. The secondary heat transfer fluid may be any similarly suitable fluid as chosen in the primary heat transfer fluid 404c. The heat transfer fluid or secondary heat transfer fluid may be used to heat components or may be converted to mechanical or electrical energy (e.g., electricity 408) to perform operations of the geothermally powered red mud processing subsystem 800.

During operation of the geothermally powered red mud processing subsystem 800, the red mud 522 (i.e., an aluminum-depleted waste residue obtained during the aluminum production process) is produced as a byproduct of the production of slurry 514b (see FIG. 5). The red mud 522 is stored in a waste collection reservoir 524 where it can then be transferred to the geothermally powered red mud processing subsystem 800 for extraction of iron, titanium/scandium, rare earth elements (REEs), and/or other components of interest. Iron is present in red mud 522 mainly in the forms of Fe₂O₃, FeOOH, and FeTiO₃. Iron can be extracted from the red mud 522 by various chemical and/or physical separation methods including magnetic separation, gravity separation, pyrometallurgy, and hydrometallurgy (e.g., acid leaching), and combinations thereof. In the example of FIG. 8, iron is separated from the red mud 522 using pyrometallurgy and magnetic separation. However, this disclosure contemplates employing any effective separation process(es).

In an example operation of the geothermally powered red mud processing subsystem 800, the red mud 522 enters the roasting furnace 802 where it is heated to an appropriate temperature (e.g., up to about 1100° C.) to reduce the main iron oxide phase Fe₂O₃ (hematite) to its magnetic form Fe²⁺Fe³⁺₂O₄ (magnetite). Other minor iron oxide phases may be similarly reduced or converted to hematite (which is then reduced to magnetite) by heating. The roasting furnace 802 is any vessel capable of heating the red mud 522 to the appropriate temperature to reduce the hematite to produce the magnetite. Pyrite FeS₂ (iron (II) disulfide) and/or sulfate salts have been historically added to the red mud 522 to induce an exothermic reaction that utilizes the sulfur as an additional fuel source. This can allow the reduction of the iron at high temperatures while using less fuel (traditionally coal or petroleum products). However, this practice releases large amounts of acidic, metallic, and other toxic compounds to the surrounding environment. By using geothermal energy, as is presented in this disclosure, high temperatures can be maintained without the use of additives, which may pollute the environment. The roasting furnace 802 is heated at least partially by heat transfer fluid 404c that is heated by the underground magma reservoir. The red mud 522 is moved into the roasting furnace 802 by a furnace conveyor 804. The furnace conveyor 804 may be driven by a geothermally powered motor 502, which can be powered using heat transfer fluid 404c and/or electricity 408. Roasted red mud 806 containing magnetite 808, which is ferrimagnetic, is the product of the roasting furnace 802.

The roasted red mud 806 is transferred to the magnetic separator 810 where the magnetite 808 is separated from the roasted red mud 806 by magnetic attraction. The magnetic separator 810 is any machine capable of moving the red mud 522 in contact with a magnetic field to remove magnetic materials from non-magnetic or weakly magnetic materials present in the roasted red mud 806. In the example of FIG. 8, the roasted red mud 806 is moved along or proximate to a magnet 812 by a magnetic separator conveyor 814. The magnetic separator conveyor 814 may be driven by a geothermally powered motor 502, which is described in more detail with respect to FIG. 5 above. The magnet 812 possesses a strongly magnetic core such as iron or steel. Examples of the magnet 812 include a portative magnet or a tractive magnet. The magnet 812 possesses a magnetic field induced by a current from electricity 408 that may be adjusted to an appropriate (e.g., a predefined) strength to attract the magnetite and other magnetic metals of interest. The magnet 812 is positioned within or proximate to the magnetic separator 810 and may be powered by a current supplied by electricity 408 derived from the conversion of heat in the heat transfer fluid 404c (e.g., by turbines 1004, 1008 of FIG. 10). The magnetite 808 is transferred to a magnetite storage vessel 816 for further processing and use in other industries.

An iron-depleted red mud 820 from the magnetic separator 810 may be transferred to the acid leaching tank 822 to extract titanium/scandium 830. Other metals of interest may be extracted in a similar method to those described in this disclosure. The metallurgical processing of the iron-depleted red mud 820 can substantially improve the energy efficiency of metal recovery and increase circular economy efforts, while simultaneously helping to achieve environmental sustainability goals by reducing the burden on primary resources. Chemical separation of titanium/scandium 830 (and other metals and rare earth elements) from the iron-depleted red mud 820 can be performed by using pH-controlled reactions with an acid 824 and/or organic solvent 828, both of which are represented collectively by block 824, 828. The acid 824 can be any appropriate type of solution of pH lower than 7 that when combined and mixed and/or agitated with the iron-depleted red mud 820 produces a leaching solution 826. For example, the acid 824 may be a sulfuric acid, hydrochloric acid, or a nitric acid. An organic solvent 828 may be used in place of, in addition to, or as a previous or subsequent step to the use of acid 824 for extracting titanium/scandium 830 from the leaching solution 826. The extraction of the titanium/scandium 830 from the leaching solution 826 can be enhanced for higher product yield by elevating the temperature of the acid leaching tank 822 (e.g., up to about 1350° C.). The acid leaching tank 822 is maintained at an elevated temperature appropriate for the extraction of titanium/scandium 830 by a heat exchanger 516 which is heated by heat transfer fluid 404c; however, the heat exchanger 516 is not shown for the sake of simplicity. The titanium/scandium 830 can be separated from the leaching solution 826 by a filter 832. The filter 832 is any device or machine capable of removing at least one component from the leaching solution 826. Filtration may be performed by chemical and/or mechanical means. In the example of FIG. 8, the filter 832 is driven by the geothermally powered motor 502. The filter 832 can be a drum filter or vacuum filter, as examples. The titanium/scandium 830 is the product, and it is transferred to a titanium storage vessel 834 for further storage, processing, and use in industries.

A metal-depleted red mud 836 from the acid leaching tank 822 may be transferred to a construction material pipeline 838 that has a series of vessels for use in producing construction materials 842. Example construction materials 842 include cement, concrete, and other building materials. As an example, the red mud 522 can be roasted or sintered to produce bricks that can be used in construction of buildings or paved paths. The vessel or vessels used to produce mixtures of construction materials 842 are maintained at an elevated temperature appropriate for roasting or sintering by a heat exchanger 516 which is heated by a heat transfer fluid 404c, but not shown herein for the sake of simplicity. Recycling the metal-depleted red mud 836 using the methods described in this disclosure is an efficient method of utilizing a waste byproduct that otherwise accumulates and presents as an environmental concern. As an example, the metal-depleted red mud 836 can be added to the construction materials 842 in amounts of up to 3.5% or greater without affecting setting times or water requirements of Portland cement and up to 20 to 50% without compromising compressive strength of the construction materials. In the example of FIG. 8, the metal-depleted red mud 836 is moved along the construction material pipeline 838 by a pipeline conveyor 840. The pipeline conveyor 840 is driven by a geothermally powered motor 502. The product is the construction materials 842.

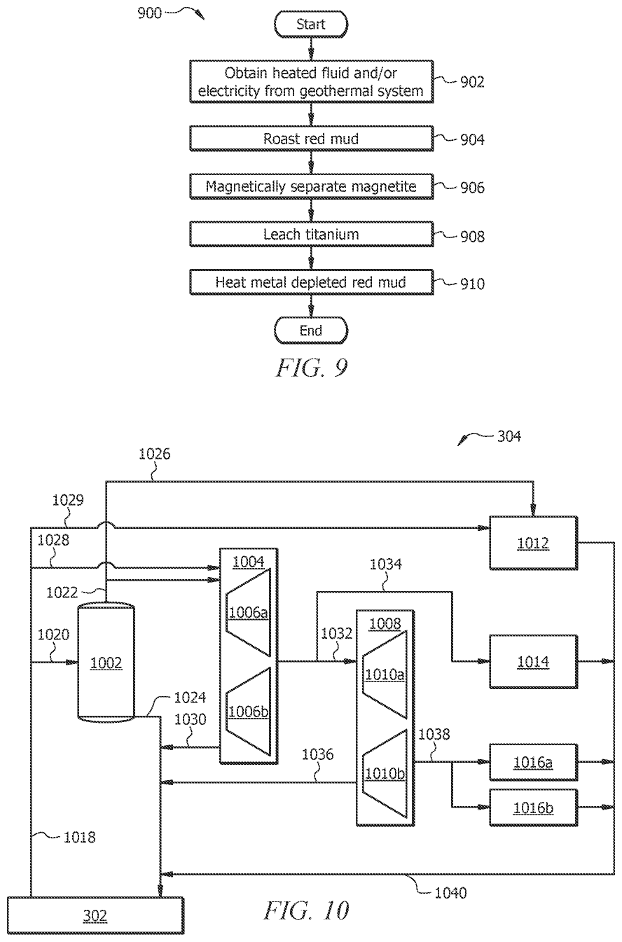

FIG. 9 shows an example method 900 of operating the geothermally powered red mud processing subsystem 800 in FIG. 8. The method 900 may begin at step 902 where the heated heat transfer fluid 404c and/or electricity 408 is received from the geothermal system, as described above with respect to FIGS. 1-4. At step 904, red mud 522 is roasted using heat from heat transfer fluid 404c. At step 906, a magnet powered by electricity 408 from geothermally powered turbines (e.g., turbines 1004, 1008 of FIG. 10) is used to extract magnetite 808 from roasted red mud 806. At step 908, iron-depleted red mud 820 is combined with an acid 824 and/or organic solvent 828 to extract titanium/scandium 830 and/or other metals and/or rare earth elements. At step 910, metal-depleted red mud is heated using heat from heat transfer fluid 404c to produce construction materials 842.

Modifications, omissions, or additions may be made to method 900 depicted in FIG. 9. Method 900 may include more, fewer, or other steps. For example, at least certain steps may be performed in parallel or in any suitable order. While at times discussed as aluminum production subsystem 500 performing steps or geothermally powered red mud processing subsystem 800, any suitable component of the aluminum production subsystem 500 or other components of a geothermal system may perform or may be used to perform one or more steps of the method 900.

### Example Thermal Process System

FIG. 10 shows a schematic diagram of an example thermal process system 304 of FIGS. 3 and 4. The thermal process system 304 includes a condenser 1002, a first turbine set 1004, a second turbine set 1008, a high-temperature/pressure thermochemical process 1012, a medium-temperature/pressure thermochemical process 1014, and one or more lower temperature/pressure processes 1016a,b. The thermal process system 304 may include more or fewer components than are shown in the example of FIG. 10. For example, a thermal process system 304 used for power generation alone may omit the high-temperature/pressure thermochemical process 1012, medium-temperature/pressure thermochemical process 1014, and lower temperature/pressure processes 1016a,b. Similarly, a thermal process system 304 that is not used for power generation may omit the turbine sets 1004, 1008. As a further example, if heat transfer fluid is known to be received only in the gas phase, the condenser 1002 may be omitted in some cases. The ability to tune the properties of the heat transfer fluid received from the unique wellbore 302 of FIGS. 3 and 4 facilitates improved and more flexible operation of the thermal process system 304. For example, the depth of the wellbore 302, the residence time of heat transfer fluid in the magma reservoir 214, the pressure achieved in the wellbore 302, and the like can be selected or adjusted to provide desired heat transfer fluid properties at the thermal process system 304.

In the example of FIG. 10, the condenser 1002 is connected to the wellbore 302 that extends between a surface and the underground magma reservoir. The condenser 1002 separates a gas-phase heat transfer fluid (e.g., steam) from liquid-phase heat transfer fluid (e.g., condensate formed from the gas-phase heat transfer fluid). The condenser 1002 may be a steam separator. A stream 1020 received from the wellbore 302 may be provided to the condenser 1002. In some cases, all of stream 1018 is provided in stream 1020. In other cases, a fraction or none of stream 1018 is provided to the condenser 1002. Instead, all or a portion of the stream 1018 may be provided as stream 1028 which may be provided to the first turbine set 1004 and/or to a high-pressure thermal process 1012 in stream 1029. The thermal process 1012 may be a thermochemical reaction requiring high temperatures and/or pressures (e.g., temperatures of between 500 and 2,000° F. and/or pressures of between 1,000 and 4,500 psig), such as the geothermally powered aluminum production subsystem 500. One or more valves (not shown for conciseness) may be used to control the direction of stream 1020 to the condenser 1002, first turbine set 1004, and/or thermal process 1012. A gas-phase stream 1022 of heat transfer fluid from the condenser may be sent to the first turbine set 1004 and/or the thermal process 1012 via stream 1026. A liquid-phase stream 1024 of heat transfer fluid from the condenser 1002 may be provided back to the wellbore 302.

The first turbine set 1004 includes one or more turbines 1006a,b. In the example of FIG. 10, the first turbine set includes two turbines 1006a,b. However, the first turbine set 1004 can include any appropriate number of turbines for a given need. The turbines 1006a,b may be any known or yet to be developed turbine for electricity generation. The turbine set 1004 is connected to the condenser 1002 and is configured to generate electricity from the gas-phase heat transfer fluid (e.g., steam) received from the condenser 1002 (stream 1022). A condensate stream 1030 exits the set of turbines 1004. The condensate stream 1030 may be provided back to the wellbore 302.

If the heat transfer fluid is at a sufficiently high temperature, as may be uniquely and more efficiently possible using the wellbore 302, a stream 1032 of gas-phase heat transfer fluid may exit the first turbine set 1004. Stream 1032 may be provided to a second turbine set 1008 to generate additional electricity. The turbines 1010a,b of the second turbine set 1008 may be the same as or similar to turbines 1006a,b, described above.

All or a portion of stream 1032 may be sent as gas-phase stream 1034 to a thermal process 1014. Process 1014 is generally a process requiring gas-phase heat transfer fluid at or near the conditions of the heat transfer fluid exiting the first turbine set 1004. For example, the thermal process 1014 may include one or more thermochemical processes requiring steam or another heat transfer fluid at or near the temperature and pressure of stream 1032 (e.g., temperatures of between 250 and 1,500° F. and/or pressures of between 500 and 2,000 psig). The second turbine set 1008 may be referred to as “low pressure turbines” because they operate at a lower pressure than the first turbine set 1004. Condensate from the second turbine set 1008 is provided back to the wellbore 302 via stream 1036.

An effluent stream 1038 from the second turbine set 1008 may be provided to one or more thermal process 1016a,b. Thermal processes 1016a,b generally require less thermal energy than processes 1012 and 1014, described above (e.g., processes 1016a,b may be performed temperatures of between 22° and 700° F. and/or pressures of between 15 and 120 psig). As an example, processes 1016a,b may include water distillation processes, heat-driven chilling processes, space heating processes, agriculture processes, aquaculture processes, and/or the like. For instance, an example heat-driven chiller process 1016a may be implemented using one or more heat driven chillers. Heat driven chillers can be implemented, for example, in data centers, crypto-currency mining facilities, or other locations in which undesirable amounts of heat are generated. Heat driven chillers, also conventionally referred to as absorption cooling systems, use heat to create chilled water. Heat driven chillers can be designed as direct-fired, indirect-fired, and heat-recovery units. When the effluent includes low pressure steam, indirect-fired units may be preferred. An effluent stream 1040 from all processes 1012, 1014, 1016a,b, may be provided back to the wellbore 1052.

The geothermally powered aluminum production subsystem 500 can achieve high temperatures via heat transfer fluids in contact with a magma chamber or in contact with heat transfer fluids heated by a magma chamber for operations that require heating. This ability to obtain high heat transfer allows deployment of alternative methods of production that were previously too energy intensive to practically implement. For example, the Bayer process of extracting alumina from bauxite is considered the industry standard—about 90% of aluminum refineries use it-due to its lower energy requirement compared to the process of sintering. Sintering permits alumina extraction from bauxite with a high silica content, which would otherwise be deemed too low quality to process and become waste, resulting in economic loss and environmental impacts. Sintering also permits alumina extraction from other silicate minerals, such as nepheline, which may be more easily accessible or readily available as mining byproducts.

The geothermally powered systems of this disclosure may reduce waste in several ways. In addition to advantages of the alternative equipment and/or methods described above, waste may further be reduced by the ability to process waste byproducts of the aluminum production subsystem into useful secondary raw materials. Waste byproducts of metal refining often sit idle and contribute to pollution of local environments. The concern for such pollution has brought a halt to aluminum processing in certain regions due to environmental concerns. The efficient and clean supply of energy from geothermal resources can power the processing of such wastes. Red mud, for example is a waste byproduct of the clarification of slurry to refine aluminum. Red mud contains valuable rare earth metals, especially scandium, iron, and titanium. Bauxite accounts for 70-80% of scandium reserves but is not currently used as a raw material for scandium extraction. In the process of aluminum production, 90% of the scandium in bauxite becomes concentrated in the red mud. This disclosure recognizes that red mud is a virtually untapped resource for extracting scandium. Additionally, waste can be reduced by reducing carbon emissions from the electrolytic reduction steps conventionally used during smelting. This reduction process requires large amounts of electrical power. Coal-fired generation emits up to 21.6 tonnes of carbon dioxide per tonne of aluminum produced, and this disclosure can achieve the same or better results without this release of carbon dioxide. As described in this disclosure, geothermal energy can power aluminum production subsystems to produce less waste and less pollution (e.g., without using coal-fired processes or with a significant decrease in the use of such processes). As such, this disclosure may facilitate aluminum production with a decreased environmental impact and decreased use of costly materials.

Although embodiments of the disclosure have been described with reference to several elements, any element described in the embodiments described herein are exemplary and can be omitted, substituted, added, combined, or rearranged as applicable to form new embodiments. A skilled person, upon reading the present specification, would recognize that such additional embodiments are effectively disclosed herein. For example, where this disclosure describes characteristics, structure, size, shape, arrangement, or composition for an element or process for making or using an element or combination of elements, the characteristics, structure, size, shape, arrangement, or composition can also be incorporated into any other element or combination of elements, or process for making or using an element or combination of elements described herein to provide additional embodiments. Moreover, items shown or discussed as coupled or directly coupled or communicating with each other may be indirectly coupled or communicating through some interface device, or intermediate component whether electrically, mechanically, fluidically, or otherwise.

### ADDITIONAL EMBODIMENTS

The following descriptive embodiments are offered in further support of the one or more aspects of the disclosure:

Embodiment 1. A geothermally powered aluminum production subsystem, comprising:
a geothermal system comprising a wellbore extending from a surface into an underground magma reservoir, the wellbore configured to heat a heat transfer fluid via heat transfer with the underground magma reservoir to form heated heat transfer fluid;
a hopper comprising a vessel configured to receive a bauxite ore and direct the received bauxite ore through a crusher;
the crusher configured to crush at least a portion of the bauxite ore;
a digestor configured to produce a slurry comprising alumina, wherein the digestor is configured to be heated by the heated heat transfer fluid;
a precipitation tank configured to produce aluminum hydroxide from the alumina in the slurry;
a calcinator configured to produce aluminum oxide from the aluminum hydroxide;
a smelter configured to produce molten aluminum from the aluminum oxide; and
a crucible configured to cast the aluminum using the molten aluminum.

Embodiment 2. The geothermally powered aluminum production subsystem of Embodiment 1, wherein the digestor is further configured to:
receive at least a portion of the crushed bauxite ore; and
produce a slurry comprising alumina.

Embodiment 3. The geothermally powered aluminum production subsystem of Embodiment 1, wherein the digestor comprises one or more heat exchangers configured to heat the crushed bauxite ore, reactants, and water via heat transfer with the heated heat transfer fluid.

Embodiment 4. The geothermally powered aluminum production subsystem of Embodiment 1, wherein a clarification tank is configured to:
receive at least a portion of a slurry produced by the digestor;
combine the received slurry with one or more flocculants; and
filter the slurry to remove impurities and produce a clarified slurry.

Embodiment 5. The geothermally powered aluminum production subsystem of Embodiment 1, wherein the precipitation tank is further configured to:
receive at least a portion of a clarified slurry;
receive seed crystals; and
transfer heat to cooling fluid provided by an absorption chiller.

Embodiment 6. The geothermally powered aluminum production subsystem of Embodiment 5, wherein the precipitation tank comprises a mixer configured to agitate the clarified slurry to facilitate precipitation of aluminum hydroxide.

Embodiment 7. The geothermally powered aluminum production subsystem of Embodiment 1, wherein the calcinator is further configured to:
receive the aluminum hydroxide precipitated in the precipitation tank; and
heat the received aluminum hydroxide through heat transfer with the heated heat transfer fluid, thereby dehydrating the aluminum hydroxide to produce the aluminum oxide.

Embodiment 8. The geothermally powered aluminum production subsystem of Embodiment 1, further comprising one or more waste collection containers configured to:
receive a red mud into a waste collection reservoir;
the waste collection reservoir configured to:
   receive the red mud from a clarification tank; and
   process the red mud to recover metals; and
recycle a spent liquor to be used for further aluminum production.

Embodiment 9. The geothermally powered aluminum production subsystem of Embodiment 1, further comprising one or more geothermally powered motors configured to use the heated heat transfer fluid to perform mechanical operations of the geothermally powered aluminum production subsystem, wherein the one or more geothermally powered motors are configured to perform one or more of:
moving the bauxite ore through the hopper;
rotating the crusher;
rotating a mixer in the precipitation tank; and
driving a conveyor to move the aluminum hydroxide through the calcinator.

Embodiment 10. The geothermally powered aluminum production subsystem of Embodiment 1, further comprising one or more turbines configured to use the heated heat transfer fluid to generate electricity, wherein the generated electricity provides an electrical current between a cathode and an anode in the smelter.

Embodiment 11. The geothermally powered aluminum production subsystem of Embodiment 1, further comprising one or more heat exchangers configured to circulate the heated heat transfer fluid to perform operations of the geothermally powered aluminum production subsystem, wherein the one or more heat exchangers are configured to perform one or more of:
heating the digestor;
heating the calcinator;
heating the smelter; and
heating the crucible.

Embodiment 12. The geothermally powered aluminum production subsystem of Embodiment 1, further comprising an absorption chiller configured to:
receive the heated heat transfer fluid; and
generate a cooling fluid using the received heat transfer fluid.

Embodiment 13. The geothermally powered aluminum production subsystem of Embodiment 12, further comprising a condenser configured to:
receive at least a portion of the cooling fluid generated by the absorption chiller; and
condense at least a portion of the heated heat transfer fluid via heat transfer with the received cooling fluid; and
allow the condensed heat transfer fluid to be returned to the wellbore of the geothermal system.

Embodiment 14. The geothermally powered aluminum production subsystem of Embodiment 1, wherein the smelter is further configured to:
receive at least a portion of the aluminum oxide produced by the calcinator;
combine the received aluminum oxide with cryolite;
heat the combined aluminum oxide with cryolite via heat transfer with the heated heat transfer fluid; and
perform reduction on the aluminum oxide to produce the molten aluminum.

Embodiment 15. The geothermally powered aluminum production subsystem of Embodiment 1, wherein the crucible is further configured to:
receive at least a portion of the molten aluminum produced by the smelter; and
heat the received molten aluminum using the heated heat transfer fluid.

Embodiment 16. A method of operating a geothermally powered aluminum production subsystem, the method comprising:
receiving heated heat transfer fluid from a geothermal system comprising a wellbore extending from a surface into an underground magma reservoir, the wellbore configured to heat a heat transfer fluid via heat transfer with the underground magma reservoir to form the heated heat transfer fluid;
receiving a bauxite ore;
crushing the bauxite ore;
producing a slurry from the crushed bauxite ore and water heated by the heated heat transfer fluid; and
extracting alumina from the slurry using heat from the heated heat transfer fluid.

Embodiment 17. The method of Embodiment 16, further comprising:
providing the heat transfer fluid down the wellbore extending from the surface and into the underground magma reservoir;
receiving the heated heat transfer fluid from the wellbore; and
transferring heat from the heated heat transfer fluid to the water combined with crushed bauxite ore to produce the slurry.

Embodiment 18. The method of Embodiment 16, wherein producing the slurry further comprises:
combining at least a portion of the crushed bauxite ore with reactants and the water in a digestor, thereby forming a mixture of the crushed bauxite ore, the reactants, and the water; and
heating the mixture using the heated heat transfer fluid to produce the slurry, wherein the slurry comprises the alumina.

Embodiment 19. The method of Embodiment 16, wherein extracting the alumina further comprises:
combining the slurry with flocculants in a clarification tank; and
clarifying the slurry with a filter to produce a clarified slurry.

Embodiment 20. The method of Embodiment 19, further comprising producing aluminum hydroxide by:
receiving at least a portion of the clarified slurry in a precipitation tank;
combining the received clarified slurry with seed crystals in the precipitation tank;
transferring heat from the heated heat transfer fluid to an absorption chiller to generate a cooling fluid; and
using the cooling fluid to cool the clarified slurry and seed crystals, thereby precipitating the aluminum hydroxide from the clarified slurry.

Embodiment 21. The method of Embodiment 20, wherein producing the aluminum hydroxide further comprises mixing the clarified slurry to facilitate precipitation of the aluminum hydroxide.

Embodiment 22. The method of Embodiment 16, further comprising directing waste products into one or more waste collection reservoirs by:
directing a red mud into the one or more waste collection reservoirs;
processing the red mud to recover one or more metals; and
recycling a spent liquor for use in further aluminum production.

Embodiment 23. The method of Embodiment 20, further comprising producing aluminum oxide by:
receiving at least a portion of the aluminum hydroxide; and
dehydrating the aluminum hydroxide to produce the aluminum oxide in a calcinator, wherein the calcinator is heated by the heated heat transfer fluid.

Embodiment 24. The method of Embodiment 23, further comprising producing molten aluminum by:
receiving at least a portion of the aluminum oxide generated in the calcinator;
combining the aluminum oxide and cryolite in a smelter, wherein the smelter comprises a smelting bath heated by the heated heat transfer fluid; and
reducing the aluminum oxide and cryolite by electrolysis to produce molten aluminum.

Embodiment 25. The method of Embodiment 24, further comprising forming aluminum by:
receiving at least a portion of the molten aluminum in a crucible;
heating the crucible using the heated heat transfer fluid; and
casting the molten aluminum in the crucible.

Embodiment 26. The method of Embodiment 16, further comprising using one or more motors powered by the heated heat transfer fluid to perform one or more of:
moving the bauxite ore through a hopper;
rotating crushers;
powering a filter in a clarification tank;
rotating a mixer in a precipitation tank; and
conveying aluminum hydroxide through a calcinator.

Embodiment 27. The method of Embodiment 16, further comprising causing one or more turbines to use the heated heat transfer fluid to generate electricity, wherein the generated electricity provides an electrical current between a cathode and an anode in a smelter of the geothermally powered aluminum production subsystem.

Embodiment 28. The method of Embodiment 16, further comprising causing one or more heat exchangers to use the heated heat transfer fluid to heat a fluid wherein the heated fluid supplies heat for one or more of:
heating a digestor;
heating a clarification tank;
heating a calcinator;
heating a smelter; and
heating a crucible.

Embodiment 29. The method of Embodiment 16, further comprising:
generating a cooling fluid using the received heat transfer fluid; and
providing the cooling fluid to one or more processes requiring cooling.

Embodiment 30. A red mud processing system, comprising:
a geothermal system comprising a wellbore extending from a surface into an underground magma reservoir, the wellbore configured to heat a heat transfer fluid via heat transfer with the underground magma reservoir to form heated heat transfer fluid;
a roasting furnace comprising a vessel configured to:
   receive red mud with at least a portion of aluminum-containing components removed; and
   heat the received red mud using the heated heat transfer fluid, thereby generating roasted red mud comprising magnetite;
a separator comprising:
   a vessel configured to receive the roasted red mud; and
   a magnet powered by geothermally generated electricity, positioned within or proximate to the vessel of the separator, and configured to remove the magnetite from the roasted red mud, thereby generating iron-depleted red mud; and an acid leaching tank comprising a vessel configured to:
   receive at least a portion of the iron-depleted red mud;
   heat a leaching solution using the heated heat transfer fluid; and
   extract one or both of titanium and scandium from the iron-depleted red mud using the heated leaching solution, thereby generating metal-depleted red mud.

Embodiment 31. The red mud processing system of Embodiment 30, further comprising a construction material pipeline comprising a series of vessels configured to:
receive at least a portion of the metal-depleted red mud;
heat the received metal-depleted red mud using the heated heat transfer fluid; and
produce construction materials using the heated metal-depleted red mud.

Embodiment 32. The red mud processing system of Embodiment 31, further comprising one or more geothermally powered motors wherein the geothermally powered motors are powered by the heated heat transfer fluid, a secondary heat transfer fluid heated by the heated heat transfer fluid, or electricity generated by the heated heat transfer fluid, wherein the one or more geothermally powered motors are configured to drive a pipeline conveyor to move the metal-depleted red mud through the construction material pipeline.

Embodiment 33. The red mud processing system of Embodiment 30, further comprising one or more geothermally powered motors powered by the heated heat transfer fluid, a secondary heat transfer fluid heated by the heated heat transfer fluid, or electricity generated by the heated heat transfer fluid, wherein the one or more geothermally powered motors are configured to perform one or more of:
rotating a mixer in the acid leaching tank;
driving a furnace conveyor to move the red mud through the roasting furnace; and
driving a magnetic separator conveyor to move the roasted red mud through the separator.

Embodiment 34. The red mud processing system of Embodiment 30, further comprising one or more heat exchangers configured to circulate the heated heat transfer fluid to perform operations of the red mud processing system, wherein the one or more heat exchangers are configured to perform one or more of:
heating the roasting furnace; and
heating the acid leaching tank.

Embodiment 35. The red mud processing system of Embodiment 30, further comprising a furnace conveyor configured to move the red mud through the roasting furnace during roasting, wherein the roasting furnace is further configured to:
reduce iron in the red mud, thereby producing a magnetic form of the iron; and
transfer the roasted red mud with the magnetic form of the iron to the separator.

Embodiment 36. The red mud processing system of Embodiment 30, wherein the separator is further configured to:
receive electricity to power the magnet;
move the roasted red mud through the separator during magnetic separation using a magnetic separator conveyor;
transfer the magnetite to a magnetite storage vessel; and
transfer at least the portion of the iron-depleted red mud to the acid leaching tank.

Embodiment 37. The red mud processing system of Embodiment 36, further comprising one or more turbines configured to use the heated heat transfer to generate the electricity used to power the magnet, wherein the generated electricity provides an electric current that induces a magnetic field that can be adjusted to a predefined strength to remove the magnetite from the roasted red mud.

Embodiment 38. The red mud processing system of Embodiment 30, wherein the acid leaching tank is further configured to:
receive an acid;
receive an organic solvent;
combine the received iron-depleted red mud with the leaching solution comprising the received acid and the received organic solvent; and
filter the leaching solution to extract the titanium and the scandium.

Embodiment 39. The red mud processing system of Embodiment 31, wherein the construction material pipeline is further configured to:
move the received metal-depleted red mud through the construction material pipeline using a pipeline conveyor; and
transfer the heated metal-depleted red mud to a series of vessels along the pipeline to be mixed with additives in appropriate amounts to produce the construction materials.

Embodiment 40. The red mud processing system of Embodiment 30, further configured to use geothermally sourced heat and/or electricity to extract one or more of:
iron in the form of magnetite produced from heating and reducing hematite during the roasting of the red mud;
iron in the form of minor oxide phases and hydroxide phases produced during the roasting of the red mud; and
titanium and scandium in oxide phases produced by leaching in the leaching solution.

Embodiment 41. A method of operating a geothermally powered red mud processing system, the method comprising:
receiving heated heat transfer fluid from a geothermal system comprising a wellbore extending from a surface into an underground magma reservoir, the wellbore configured to heat a heat transfer fluid via heat transfer with the underground magma reservoir to form the heated heat transfer fluid;
receiving a red mud with at least a portion of aluminum containing components removed;
heating the received red mud using the heated heat transfer fluid thereby generating a roasted red mud comprising magnetite;
removing the magnetite from the roasted red mud using a magnet powered by geothermally generated electricity, thereby producing an iron-depleted red mud;
heating a leaching solution using the heated heat transfer fluid; and
extracting one or both of titanium and scandium from the iron-depleted red mud using the heated leaching solution, thereby generating a metal-depleted red mud.

Embodiment 42. The method of Embodiment 41, wherein receiving the heat transfer fluid comprises:
providing the heat transfer fluid down the wellbore extending from the surface and into the underground magma reservoir; and
receiving the heated heat transfer fluid from the wellbore.

Embodiment 43. The method of Embodiment 41, wherein using heat from the heat transfer fluid to generate mechanical or electrical energy with turbines further comprises:
powering geothermally powered motors with the heated heat transfer fluid, a secondary heat transfer fluid heated by the heated heat transfer fluid, or electricity generated by the heated heat transfer fluid, wherein the geothermally powered motors are configured to perform one or more of:
   rotating one or more mixers; and
   driving one or more conveyors used to move materials.

Embodiment 44. The method of Embodiment 41, wherein heating the received red mud using the heated heat transfer fluid further comprises:
moving the received red mud using a conveyor during the heating of the received red mud; and
reducing iron in the received red mud.

Embodiment 45. The method of Embodiment 41, wherein removing the magnetite from the roasted red mud further comprises moving the roasted red mud during magnetic separation using a conveyor.

Embodiment 46. The method of Embodiment 45, wherein removing the magnetite from the roasted red mud further comprises:
generating the geothermally generated electricity with one or more turbines using the heated heat transfer fluid; and
providing the geothermally generated electricity to the magnet, wherein the geothermally generated electricity provides an electric current that induces a magnetic field in the magnet that can be adjusted to a predefined strength to separate the magnetite.

Embodiment 47. The method of Embodiment 41, wherein extracting the titanium and the scandium from the iron-depleted red mud using the leaching solution further comprises:
agitating the leaching solution with a motor powered by one or more of the heat transfer fluid and the geothermally generated electricity;
combining the iron-depleted red mud with the leaching solution to separate the titanium and the scandium from the iron-depleted red mud, wherein the leaching solution comprises one or more of an acid and an organic solvent; and
filtering the titanium and the scandium from the leaching solution.

Embodiment 48. The method of Embodiment 41, further comprising:
heating the metal-depleted red mud via the heated heat transfer fluid; and producing construction materials using the heated metal-depleted red mud.

Embodiment 49. The method of Embodiment 48, wherein producing the construction materials using the heated metal-depleted red mud further comprises:
moving the heated metal-depleted red mud using a conveyor; and
   transferring the heated metal-depleted red mud to a series of vessels along a pipeline, wherein the heated metal-depleted red mud is added to various mixtures to produce the construction materials

While this disclosure has been particularly shown and described with reference to preferred or example embodiments, it will be understood by those skilled in the art that various changes in form and detail may be made therein without departing from the spirit and scope of the disclosure. Accordingly, this disclosure includes all modifications and equivalents of the subject matter recited in the claims appended hereto as permitted by applicable law. Changes, substitutions and alterations are ascertainable by one skilled in the art and could be made without departing from the spirit and scope disclosed herein. Moreover, any combination of the above-described elements in all possible variations thereof is encompassed by the disclosure unless otherwise indicated herein or otherwise clearly contradicted by context.

Additionally, where an embodiment is described herein as comprising some element or group of elements, additional embodiments can consist essentially of or consist of the element or group of elements. Also, although the open-ended term “comprises” is generally used herein, additional embodiments can be formed by substituting the terms “consisting essentially of” or “consisting of.”

What is claimed is:

1. A geothermally powered aluminum production subsystem, comprising:
a geothermal system comprising a wellbore extending from a surface into an underground magma reservoir, the wellbore configured to heat a heat transfer fluid via heat transfer with the underground magma reservoir to form heated heat transfer fluid;
a hopper comprising a vessel configured to receive a bauxite ore and direct the received bauxite ore through a crusher;
the crusher configured to crush at least a portion of the bauxite ore;
a digestor configured to produce a slurry comprising alumina, wherein the digestor is configured to be heated by the heated heat transfer fluid;
a precipitation tank configured to produce aluminum hydroxide from the alumina in the slurry;
a calcinator configured to produce aluminum oxide from the aluminum hydroxide;
a smelter configured to produce molten aluminum from the aluminum oxide; and
a crucible configured to cast the aluminum using the molten aluminum.

2. The geothermally powered aluminum production subsystem of claim 1, wherein the digestor is further configured to:
receive at least a portion of the crushed bauxite ore; and
produce a slurry comprising alumina.

3. The geothermally powered aluminum production subsystem of claim 1, wherein the digestor comprises one or more heat exchangers configured to heat the crushed bauxite ore, reactants, and water via heat transfer with the heated heat transfer fluid.

4. The geothermally powered aluminum production subsystem of claim 1, wherein a clarification tank is configured to:
receive at least a portion of a slurry produced by the digestor;
combine the received slurry with one or more flocculants; and
filter the slurry to remove impurities and produce a clarified slurry.

5. The geothermally powered aluminum production subsystem of claim 1, wherein the precipitation tank is further configured to:
receive at least a portion of a clarified slurry;
receive seed crystals; and
transfer heat to cooling fluid provided by an absorption chiller.

6. The geothermally powered aluminum production subsystem of claim 5, wherein the precipitation tank comprises a mixer configured to agitate the clarified slurry to facilitate precipitation of aluminum hydroxide.

7. The geothermally powered aluminum production subsystem of claim 1, wherein the calcinator is further configured to:
receive the aluminum hydroxide precipitated in the precipitation tank; and
heat the received aluminum hydroxide through heat transfer with the heated heat transfer fluid, thereby dehydrating the aluminum hydroxide to produce the aluminum oxide.

8. The geothermally powered aluminum production subsystem of claim 1, further comprising one or more waste collection containers configured to:
receive a red mud into a waste collection reservoir;
the waste collection reservoir configured to:
receive the red mud from a clarification tank; and
process the red mud to recover metals; and
recycle a spent liquor to be used for further aluminum production.

9. The geothermally powered aluminum production subsystem of claim 1, further comprising one or more geothermally powered motors configured to use the heated heat transfer fluid to perform mechanical operations of the geothermally powered aluminum production subsystem, wherein the one or more geothermally powered motors are configured to perform one or more of:
moving the bauxite ore through the hopper;
rotating the crusher;
rotating a mixer in the precipitation tank; and
driving a conveyor to move the aluminum hydroxide through the calcinator.

10. The geothermally powered aluminum production subsystem of claim 1, further comprising one or more turbines configured to use the heated heat transfer fluid to generate electricity, wherein the generated electricity provides an electrical current between a cathode and an anode in the smelter.

11. The geothermally powered aluminum production subsystem of claim 1, further comprising one or more heat exchangers configured to circulate the heated heat transfer fluid to perform operations of the geothermally powered aluminum production subsystem, wherein the one or more heat exchangers are configured to perform one or more of:
heating the digestor;
heating the calcinator;
heating the smelter; and
heating the crucible.

12. The geothermally powered aluminum production subsystem of claim 1, further comprising an absorption chiller configured to:
receive the heated heat transfer fluid; and
generate a cooling fluid using the received heat transfer fluid.

13. The geothermally powered aluminum production subsystem of claim 12, further comprising a condenser configured to:
receive at least a portion of the cooling fluid generated by the absorption chiller; and
condense at least a portion of the heated heat transfer fluid via heat transfer with the received cooling fluid; and
allow the condensed heat transfer fluid to be returned to the wellbore of the geothermal system.

14. The geothermally powered aluminum production subsystem of claim 1, wherein the smelter is further configured to:
receive at least a portion of the aluminum oxide produced by the calcinator;
combine the received aluminum oxide with cryolite;
heat the combined aluminum oxide with cryolite via heat transfer with the heated heat transfer fluid; and
perform reduction on the aluminum oxide to produce the molten aluminum.

15. The geothermally powered aluminum production subsystem of claim 1, wherein the crucible is further configured to:
receive at least a portion of the molten aluminum produced by the smelter; and
heat the received molten aluminum using the heated heat transfer fluid.

16. A method of operating a geothermally powered aluminum production subsystem, the method comprising:
receiving heated heat transfer fluid from a geothermal system comprising a wellbore extending from a surface into an underground magma reservoir, the wellbore configured to heat a heat transfer fluid via heat transfer with the underground magma reservoir to form the heated heat transfer fluid;
receiving a bauxite ore;
crushing the bauxite ore;
producing a slurry from the crushed bauxite ore and water heated by the heated heat transfer fluid; and
extracting alumina from the slurry using heat from the heated heat transfer fluid.

17. The method of claim 16, further comprising:
providing the heat transfer fluid down the wellbore extending from the surface and into the underground magma reservoir;
receiving the heated heat transfer fluid from the wellbore; and
transferring heat from the heated heat transfer fluid to the water combined with crushed bauxite ore to produce the slurry.

18. The method of claim 16, wherein producing the slurry further comprises:
combining at least a portion of the crushed bauxite ore with reactants and the water in a digestor, thereby forming a mixture of the crushed bauxite ore, the reactants, and the water; and
heating the mixture using the heated heat transfer fluid to produce the slurry, wherein the slurry comprises the alumina.

19. The method of claim 16, wherein extracting the alumina further comprises:
combining the slurry with flocculants in a clarification tank; and
clarifying the slurry with a filter to produce a clarified slurry.

20. The method of claim 19, further comprising producing aluminum hydroxide by:
receiving at least a portion of the clarified slurry in a precipitation tank;
combining the received clarified slurry with seed crystals in the precipitation tank;
transferring heat from the heated heat transfer fluid to an absorption chiller to generate a cooling fluid; and
using the cooling fluid to cool the clarified slurry and seed crystals, thereby precipitating the aluminum hydroxide from the clarified slurry.

21. The method of claim 20, wherein producing the aluminum hydroxide further comprises mixing the clarified slurry to facilitate precipitation of the aluminum hydroxide.

22. The method of claim 16, further comprising directing waste products into one or more waste collection reservoirs by:
directing a red mud into the one or more waste collection reservoirs;
processing the red mud to recover one or more metals; and
recycling a spent liquor for use in further aluminum production.

23. The method of claim 20, further comprising producing aluminum oxide by:
receiving at least a portion of the aluminum hydroxide; and
dehydrating the aluminum hydroxide to produce the aluminum oxide in a calcinator, wherein the calcinator is heated by the heated heat transfer fluid.

24. The method of claim 23, further comprising producing molten aluminum by:
receiving at least a portion of the aluminum oxide generated in the calcinator;
combining the aluminum oxide and cryolite in a smelter, wherein the smelter comprises a smelting bath heated by the heated heat transfer fluid; and
reducing the aluminum oxide and cryolite by electrolysis to produce molten aluminum.

25. The method of claim 24, further comprising forming aluminum by:
receiving at least a portion of the molten aluminum in a crucible;
heating the crucible using the heated heat transfer fluid; and
casting the molten aluminum in the crucible.

26. The method of claim 16, further comprising using one or more motors powered by the heated heat transfer fluid to perform one or more of:
moving the bauxite ore through a hopper;
rotating crushers;
powering a filter in a clarification tank;
rotating a mixer in a precipitation tank; and
conveying aluminum hydroxide through a calcinator.

27. The method of claim 16, further comprising causing one or more turbines to use the heated heat transfer fluid to generate electricity, wherein the generated electricity provides an electrical current between a cathode and an anode in a smelter of the geothermally powered aluminum production subsystem.

28. The method of claim 16, further comprising causing one or more heat exchangers to use the heated heat transfer fluid to heat a fluid wherein the heated fluid supplies heat for one or more of:
heating a digestor,
heating a clarification tank;
heating a calcinator;
heating a smelter; and
heating a crucible.

29. The method of claim 16, further comprising:
generating a cooling fluid using the received heat transfer fluid; and
providing the cooling fluid to one or more processes requiring cooling.
